(19) United States
(12) Patent Application Publication
(10) Pub. No.: US 2014/0253413 A1
(43) Pub. Date: Sep. 11, 2014

(54) SYSTEM, METHOD, AND COMPUTER PROGRAM PRODUCT FOR REPRESENTING A GROUP OF MONITORS PARTICIPATING IN A DESKTOP SPANNING ENVIRONMENT TO AN OPERATING SYSTEM

(71) Applicant: NVIDIA CORPORATION, Santa Clara, CA (US)

(72) Inventors: Rishi Nair, Issaquah, WA (US); Aung Myo Oo, Bellevue, WA (US)

(73) Assignee: NVIDIA Corporation, Santa Clara, CA (US)

(21) Appl. No.: 13/787,697

(22) Filed: Mar. 6, 2013

(51) Int. Cl. G06F 3/14

(52) U.S. Cl. CPC G06F 3/1446
USPC 345/1.3

(57) ABSTRACT

A system, method, and computer program product for representing a plurality of display devices configured to participate in a desktop spanning environment is disclosed. The method includes the steps of simulating a hot-unplug event for a plurality of display devices configured to participate in a spanned desktop environment and simulating a hot-plug event for a logical display device that represents the plurality of display devices.

### FIELD OF THE INVENTION

The present invention relates to computer monitors, and more particularly to the representation of a group of monitors participating in desktop spanning to an operating system.

### BACKGROUND

Conventionally, a desktop computer or a laptop computer was connected to a single physical display device such as a cathode ray tube (CRT) monitor or a liquid crystal display (LCD) monitor. The physical display device typically included a cable for a particular type of video interface (e.g., VGA, DVI, etc.) to attach to a connector on the back of the computer. The connector was coupled to a graphics processing unit (GPU) that generated pixel data or video signals for display on the surface of the physical display device. More recently, computer systems began implementing multiple GPUs or single GPUs with multiple display connectors for attaching multiple monitors to the same computer. Desktop spanning (i.e., also known as multi-monitor, multi-display, or multi-head technology) enables a single video surface to be extended and displayed across multiple physical display devices.

One issue with attaching multiple display devices to a single computer is the manner in which those display devices are represented within the operating system. The operating system (OS) may implement a graphical user interface (GUI) that appears, for example, as a small icon in a system tray of the desktop. The user can click on the icon to open an application window that provides the user with information about the physical display devices connected to the computer. When desktop spanning is implemented, however, conventional display devices continue to represent the single logical display as multiple physical display devices within the GUI of the OS. In other words, the driver may indicate that one of the physical display devices is actively displaying the main desktop while the other physical display devices are inactive, even though all of the physical display devices connected to the computer are participating in the desktop spanning architecture. This can lead to confusion among users who may try to connect one of the “inactive” display devices to another video output of the computer (via a configuration setting), thereby breaking the functionality of the desktop spanning architecture. Thus, there is a need for representing a group of monitors participating in desktop spanning to an operating system that addresses this issue and/or other issues associated with the prior art.

### SUMMARY

A system, method, and computer program product for representing a plurality of display devices configured to participate in a desktop spanning environment is disclosed. The method includes the steps of simulating a hot-unplug event for a plurality of display devices configured to participate in a spanned desktop environment and simulating a hot-plug event for a logical display device that represents the plurality of display devices.

### BRIEF DESCRIPTION OF THE DRAWINGS

FIG. 1 illustrates a flowchart of a method for representing a group of monitors participating in a desktop spanning environment to an operating system, in accordance with one embodiment;

FIG. 2 illustrates a parallel processing unit, according to one embodiment;

FIG. 3 illustrates the streaming multi-processor of FIG. 2, according to one embodiment;

FIG. 4 illustrates a system for implementing desktop spanning, in accordance with one embodiment;

FIG. 5 illustrates a flowchart of a method for representing a group of monitors participating in a desktop spanning environment to an operating system, in accordance with another embodiment; and

FIG. 6 illustrates an exemplary system in which the various architecture and/or functionality of the various previous embodiments may be implemented.

### DETAILED DESCRIPTION

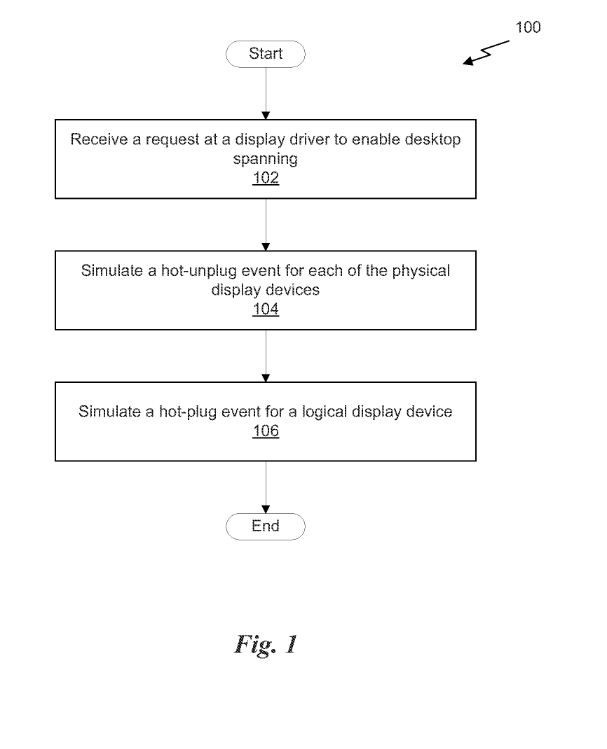

FIG. 1 illustrates a flowchart 100 of a method for representing a group of monitors participating in a desktop spanning environment to an operating system, in accordance with one embodiment. At step 102, receive a request is at a display driver to enable desktop spanning on a plurality of physical display devices. At step 104, the display driver simulates a hot-unplug event for each of the physical display devices. In one embodiment, the display driver notifies the operating system of the hot-unplug event similar to if the display driver detected that the physical display device had been manually disconnected from the computer. At step 106, the display driver simulates a hot-plug event for a logical display device that represents the plurality of display devices participating in a desktop spanning environment. In one embodiment, the display driver notifies the operating system of the hot-plug event similar to if the display driver detected that a physical display device had been manually connected to the computer. The logical display device data structure includes information associated with the characteristics of the spanned desktop environment. In other words, the logical display device represents a theoretical display device comprising the combined dimensions of each of the physical display devices participating in the spanned desktop environment.

It should be noted that, while various optional features are set forth herein in connection with representing a group of monitors participating in desktop spanning, such features are for illustrative purposes only and should not be construed as limiting in any manner. In one embodiment, the method described above is implemented in a display driver for a parallel processing unit.

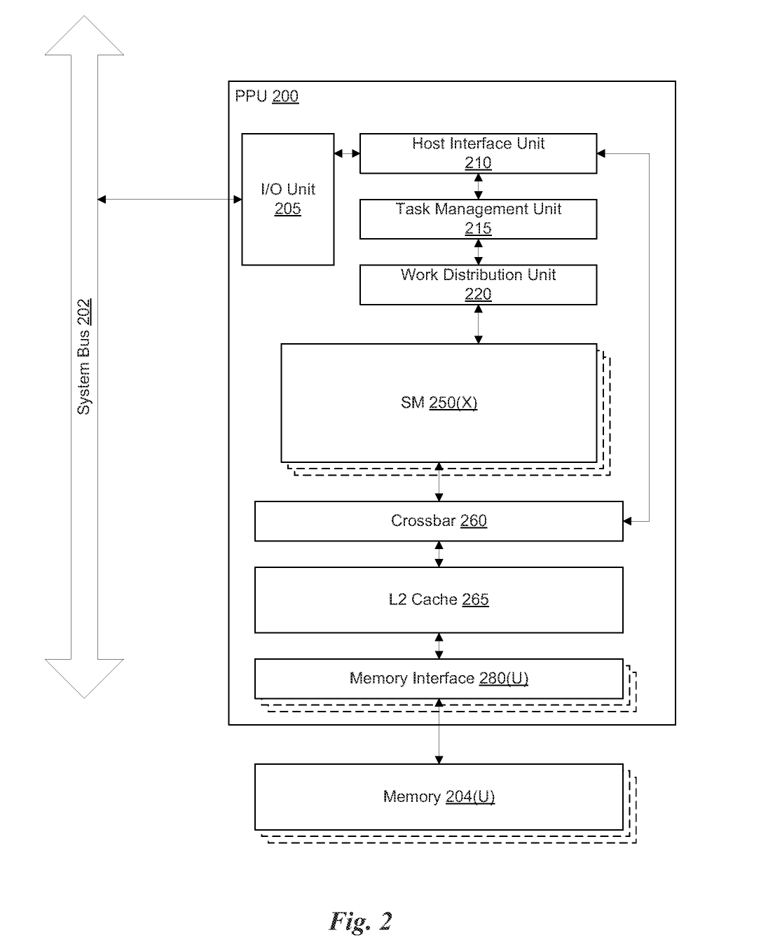

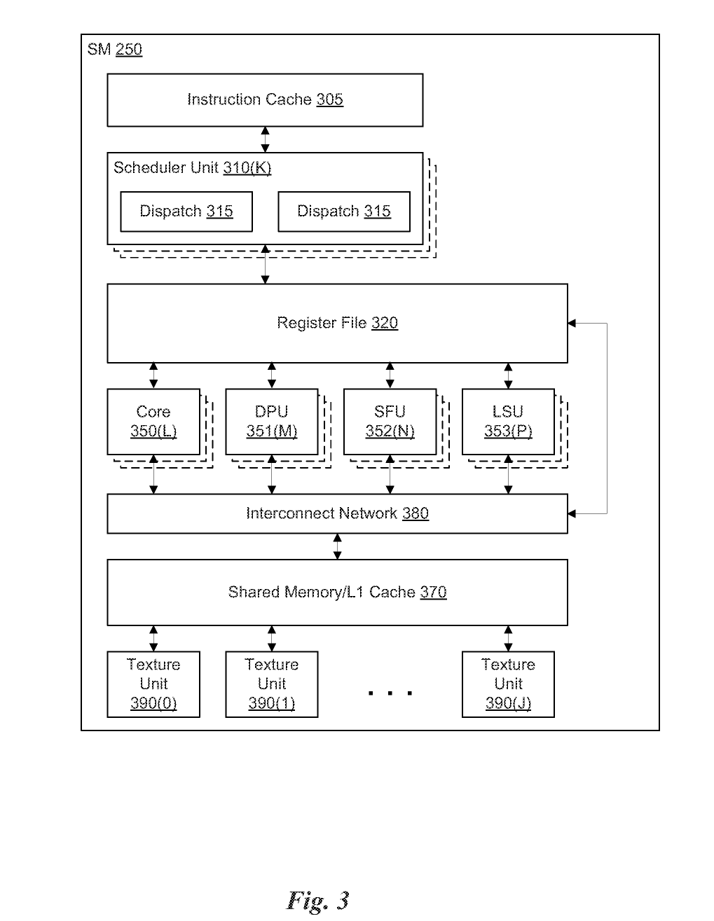

FIG. 2 illustrates a parallel processing unit (PPU) 200, according to one embodiment. While a parallel processor is provided herein as an example of the PPU 200, it should be strongly noted that such processor is set forth for illustrative purposes only, and any processor may be employed to supplement and/or substitute for the same. In one embodiment, the PPU 200 is configured to execute a plurality of threads concurrently in two or more streaming multi-processors (SMs) 250. A thread (i.e., a thread of execution) is an instantiation of a set of instructions executing within a particular SM 250. Each SM 250, described below in more detail in conjunction with FIG. 3, may include, but is not limited to, one or more processing cores, one or more load/store units (LSUs), a level-one (L1) cache, shared memory, and the like.

In one embodiment, the PPU 200 includes an input/output (I/O) unit 205 configured to transmit and receive communications (i.e., commands, data, etc.) from a central processing unit (CPU) (not shown) over the system bus 202. The I/O unit 205 may implement a Peripheral Component Interconnect Express (PCIe) interface for communications over a PCIe bus. In alternative embodiments, the I/O unit 205 may implement other types of well-known bus interfaces.

The PPU 200 also includes a host interface unit 210 that decodes the commands and transmits the commands to the task management unit 215 or other units of the PPU 200 (e.g., memory interface 280) as the commands may specify. The host interface unit 210 is configured to route communications between and among the various logical units of the PPU 200.

In one embodiment, a program encoded as a command stream is written to a buffer by the CPU. The buffer is a region in memory, e.g., memory 204 or system memory, that is accessible (i.e., read/write) by both the CPU and the PPU 200. The CPU writes the command stream to the buffer and then transmits a pointer to the start of the command stream to the PPU 200. The host interface unit 210 provides the task management unit (TMU) 215 with pointers to one or more streams. The TMU 215 selects one or more streams and is configured to organize the selected streams as a pool of pending grids. The pool of pending grids may include new grids that have not yet been selected for execution and grids that have been partially executed and have been suspended.

A work distribution unit 220 that is coupled between the TMU 215 and the SMs 250 manages a pool of active grids, selecting and dispatching active grids for execution by the SMs 250. Pending grids are transferred to the active grid pool by the TMU 215 when a pending grid is eligible to execute, i.e., has no unresolved data dependencies. An active grid is transferred to the pending pool when execution of the active grid is blocked by a dependency. When execution of a grid is completed, the grid is removed from the active grid pool by the work distribution unit 220. In addition to receiving grids from the host interface unit 210 and the work distribution unit 220, the TMU 215 also receives grids that are dynamically generated by the SMs 250 during execution of a grid. These dynamically generated grids join the other pending grids in the pending grid pool.

In one embodiment, the CPU executes a driver kernel that implements an application programming interface (API) that enables one or more applications executing on the CPU to schedule operations for execution on the PPU 200. An application may include instructions (i.e., API calls) that cause the driver kernel to generate one or more grids for execution. In one embodiment, the PPU 200 implements a SIMD (Single-Instruction, Multiple-Data) architecture where each thread block (i.e., warp) in a grid is concurrently executed on a different data set by different threads in the thread block. The driver kernel defines thread blocks that are comprised of k related threads, such that threads in the same thread block may exchange data through shared memory. In one embodiment, a thread block comprises 32 related threads and a grid is an array of one or more thread blocks that execute the same stream and the different thread blocks may exchange data through global memory.

In one embodiment, the PPU 200 comprises X SMs 250(X). For example, the PPU 200 may include 15 distinct SMs 250. Each SM 250 is multi-threaded and configured to execute a plurality of threads (e.g., 32 threads) from a particular thread block concurrently. Each of the SMs 250 is connected to a level-two (L2) cache 265 via a crossbar 260 (or other type of interconnect network). The L2 cache 265 is connected to one or more memory interfaces 280. Memory interfaces 280 implement 16, 32, 64, 128-bit data buses, or the like, for high-speed data transfer. In one embodiment, the PPU 200 comprises U memory interfaces 280(U), where each memory interface 280(U) is connected to a corresponding memory device 204(U). For example, PPU 200 may be connected to up to 6 memory devices 204, such as graphics double-data-rate, version 5, synchronous dynamic random access memory (GDDR5 SDRAM).

In one embodiment, the PPU 200 implements a multi-level memory hierarchy. The memory 204 is located off-chip in SDRAM coupled to the PPU 200. Data from the memory 204 may be fetched and stored in the L2 cache 265, which is located on-chip and is shared between the various SMs 250. In one embodiment, each of the SMs 250 also implements an L1 cache. The L1 cache is private memory that is dedicated to a particular SM 250. Each of the L1 caches is coupled to the shared L2 cache 265. Data from the L2 cache 265 may be fetched and stored in each of the L1 caches for processing in the functional units of the SMs 250.

In one embodiment, the PPU 200 comprises a graphics processing unit (GPU). The PPU 200 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 200 can be configured to process the graphics primitives to generate a frame buffer (i.e., pixel data for each of the pixels of the display). The driver kernel implements a graphics processing pipeline, such as the graphics processing pipeline defined by the OpenGL API.

An application writes model data for a scene (i.e., a collection of vertices and attributes) to memory. The model data defines each of the objects that may be visible on a display. The application then makes an API call to the driver kernel that requests the model data to be rendered and displayed. The driver kernel reads the model data and writes commands to the buffer to perform one or more operations to process the model data. The commands may encode different shader programs including one or more of a vertex shader, hull shader, geometry shader, pixel shader, etc. For example, the TMU 215 may configure one or more SMs 250 to execute a vertex shader program that processes a number of vertices defined by the model data. In one embodiment, the TMU 215 may configure different SMs 250 to execute different shader programs concurrently. For example, a first subset of SMs 250 may be configured to execute a vertex shader program while a second subset of SMs 250 may be configured to execute a pixel shader program. The first subset of SMs 250 processes vertex data to produce processed vertex data and writes the processed vertex data to the L2 cache 265 and/or the memory 204. After the processed vertex data is rasterized (i.e., transformed from three-dimensional data into two-dimensional data in screen space) to produce fragment data, the second subset of SMs 250 executes a pixel shader to produce processed fragment data, which is then blended with other processed fragment data and written to the frame buffer in memory 204. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device or a plurality of display devices configured for desktop spanning.

The PPU 200 may be included in a desktop computer, a laptop computer, a tablet computer, a smart-phone (e.g., a wireless, hand-held device), personal digital assistant (PDA), a digital camera, a hand-held electronic device, and the like. In one embodiment, the PPU 200 is embodied on a single semiconductor substrate. In another embodiment, the PPU 200 is included in a system-on-a-chip (SoC) along with one or more other logic units such as a reduced instruction set computer (RISC) CPU, a memory management unit (MMU), a digital-to-analog converter (DAC), and the like.

In one embodiment, the PPU 200 may be included on a graphics card that includes one or more memory devices 204 such as GDDR5 SDRAM. The graphics card may be configured to interface with a PCIe slot on a motherboard of a desktop computer that includes, e.g., a northbridge chipset and a southbridge chipset. In yet another embodiment, the PPU 200 may be an integrated graphics processing unit (iGPU) included in the chipset (i.e., Northbridge) of the motherboard.

FIG. 3 illustrates the streaming multi-processor 250 of FIG. 2, according to one embodiment. As shown in FIG. 3, the SM 250 includes an instruction cache 305, one or more scheduler units 310, a register file 320, one or more processing cores 350, one or more double precision units (DPUs) 351, one or more special function units (SFUs) 352, one or more load/store units (LSUs) 353, an interconnect network 380, a shared memory/L1 cache 370, and one or more texture units 390.

As described above, the work distribution unit 220 dispatches active grids for execution on one or more SMs 250 of the PPU 200. The scheduler unit 310 receives the grids from the work distribution unit 220 and manages instruction scheduling for one or more thread blocks of each active grid. The scheduler unit 310 schedules threads for execution in groups of parallel threads, where each group is called a warp. In one embodiment, each warp includes 32 threads. The scheduler unit 310 may manage a plurality of different thread blocks, allocating the thread blocks to warps for execution and then scheduling instructions from the plurality of different warps on the various functional units (i.e., cores 350, DPUs 351, SFUs 352, and LSUs 353) during each clock cycle.

In one embodiment, each scheduler unit 310 includes one or more instruction dispatch units 315. Each dispatch unit 315 is configured to transmit instructions to one or more of the functional units. In the embodiment shown in FIG. 3, the scheduler unit 310 includes two dispatch units 315 that enable two different instructions from the same warp to be dispatched during each clock cycle. In alternative embodiments, each scheduler unit 310 may include a single dispatch unit 315 or additional dispatch units 315.

Each SM 250 includes a register file 320 that provides a set of registers for the functional units of the SM 250. In one embodiment, the register file 320 is divided between each of the functional units such that each functional unit is allocated a dedicated portion of the register file 320. In another embodiment, the register file 320 is divided between the different warps being executed by the SM 250. The register file 320 provides temporary storage for operands connected to the data paths of the functional units.

Each SM 250 comprises L processing cores 350. In one embodiment, the SM 250 includes a large number (e.g., 192, etc.) of distinct processing cores 350. Each core 350 is a fully-pipelined, single-precision processing unit that includes a floating point arithmetic logic unit and an integer arithmetic logic unit. In one embodiment, the floating point arithmetic logic units implement the IEEE 754-2008 standard for floating point arithmetic. Each SM 250 also comprises M DPUs 351 that implement double-precision floating point arithmetic, N SFUs 352 that perform special functions (e.g., copy rectangle, pixel blending operations, and the like), and P LSUs 353 that implement load and store operations between the shared memory/L1 cache 370 and the register file 320. In one embodiment, the SM 250 includes 64 DPUs 351, 32 SFUs 352, and 32 LSUs 353.

Each SM 250 includes an interconnect network 380 that connects each of the functional units to the register file 320 and the shared memory/L1 cache 370. In one embodiment, the interconnect network 380 is a crossbar that can be configured to connect any of the functional units to any of the registers in the register file 320 or the memory locations in shared memory/L1 cache 370.

In one embodiment, the SM 250 is implemented within a GPU. In such an embodiment, the SM 250 comprises J texture units 390. The texture units 390 are configured to load texture maps (i.e., a 2D array of texels) from the memory 204 and sample the texture maps to produce sampled texture values for use in shader programs. The texture units 390 implement texture operations such as anti-aliasing operations using mip-maps (i.e., texture maps of varying levels of detail). In one embodiment, the SM 250 includes 16 texture units 390.

The PPU 200 described above may be configured to perform highly parallel computations much faster than conventional CPUs. Parallel computing has advantages in graphics processing, data compression, biometrics, stream processing algorithms, and the like.

### Desktop Spanning

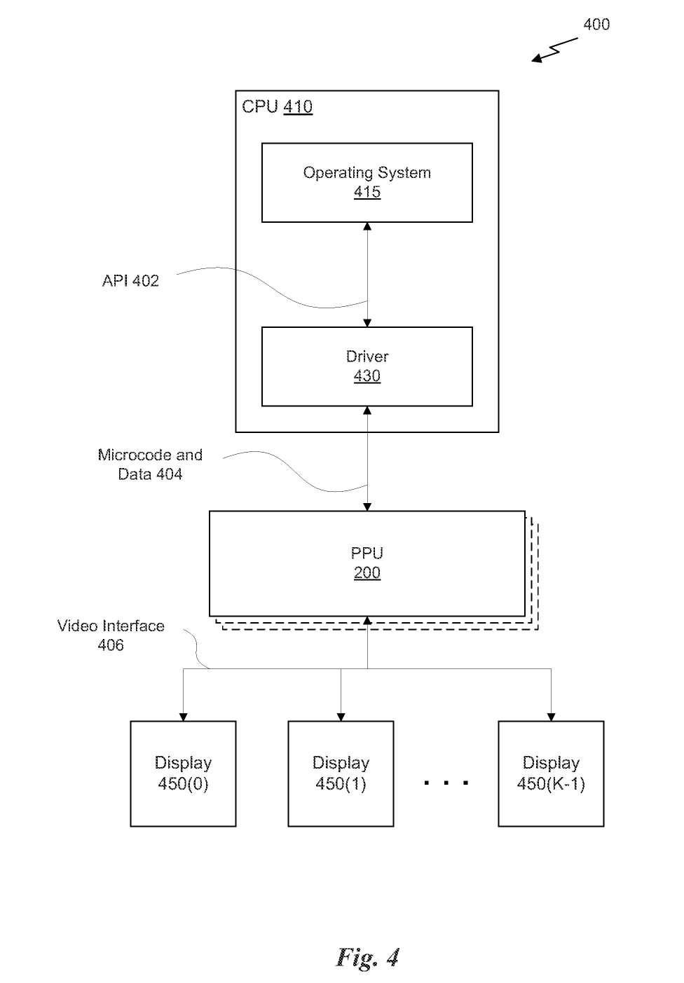

FIG. 4 illustrates a system 400 for implementing desktop spanning, in accordance with one embodiment. As shown in FIG. 4, the system 400 includes a CPU 410, one or more PPUs 200, and a plurality of physical display devices 450. In one embodiment, desktop spanning is implemented on K physical display devices 450 coupled to the one or more PPUs 200 via a video interface 406. The video interface 406 may be any conventional video interface well-known in the art, such as Video Graphics Array (VGA), Digital Visual Interface (DVI), or DisplayPort (DP). The CPU 410 executes an operating system 415 and a display driver 430. The operating system 415 may be an operating system such as Microsoft™ Windows, Apple™ OSX, or one of the distributions of the Linux™ kernel such as Linux Ubuntu.

In one embodiment, the physical display devices 450 may be implemented in a desktop spanning environment. In the desktop spanning environment, a display grid is defined as m rows×n columns of display devices 450 (i.e., an m×n display grid). For example, the system 400 may include three physical display devices 450 arranged adjacent to each other left-to-right, in a 1×3 display matrix. Each display may be, e.g., a 1920×1080 resolution LCD display device. The desktop spanning environment establishes a logical surface having a resolution of 5760×1080 pixels. In other words, the surface displayed on the spanned desktop is three times as wide as a surface that can be displayed on a single display device 450. In another example, the system 400 may include four physical display devices 450 arranged in a 2×2 display matrix. The desktop spanning configuration establishes a logical surface having a resolution of 3840×2160 pixels. In other words, the surface displayed on the spanned desktop is twice as wide and twice as high as a surface that can be displayed on a single display device 450.

As used herein, a surface is a data structure that stores pixel data for display on a physical display device. For example, a surface may comprise a frame buffer stored in a memory. The PPU 200 may render graphics data generated by an application to generate pixel data stored in the frame buffer. The pixel data is then transmitted to one or more of the physical display devices 450 to generate an image for display. In one embodiment, the operating system 415 as well as one or more applications (not shown) may implement API calls 402 that are received by a display driver 430. The display driver 430 implements the API and generates microcode and data 404 that are transmitted to the one or more PPUs 200. The PPUs 200 generate pixel data in one or more frame buffers, and the pixel data is transmitted to the physical display devices 450 to generate images on the display.

Video interfaces 406 typically implement a hot plug/unplug capability. In other words, when a display device 450 is plugged (i.e., physically coupled) into the system 400 while the power is on, a signal indicates to the display driver 430 that a display device 450 has been added to the system 400. The display driver 430 may notify the operating system 415 that a display device 450 has been connected by generating a system message (such as by generating a software interrupt). In one case, such as in the Microsoft™ Windows 7 operating system, the display driver 430 (and the display device 450) may generate a hardware interrupt via an interrupt request channel transmitted via a system bus. The operating system, in servicing the hardware interrupt, generates a call into the display driver 430 (via the API) to handle the interrupt. The display driver 430 may perform operations, such as making system calls to the operating system, that cause the display topology to be reconfigured.

In one embodiment, the operating system 415 may configure a new display topology generating different display surfaces for each of the display devices 450 connected to the system 400. The display driver 430 may also configure the display device 450 for operation such as by transmitting commands to the display device 450 to configure the resolution of the video signals transmitted to the display device 450. Similarly, when the display device 450 is unplugged from the system 400 while the power is on, a signal indicates to the display driver 430 that the display device 450 has been removed or unplugged (i.e., physically decoupled) from the system 400. The display driver 430 may notify the operating system 415 that the display device 450 has been disconnected by generating a system message. The operating system 415 may reconfigure the display topology based on the removal of the display device 450.

Conventional display drivers 430 are designed to generate system messages indicating that a display device 450 has been hot plugged or hot unplugged in response to the signal associated with the video interface 406. In other words, the operating system 415 is made aware of each of the physical display devices 450 coupled to the system 400 regardless of whether the display topology is configured to display a different surface on each of the physical display devices 450 or span a single logical surface across multiple display devices. Again, as discussed above, the user interface may show representations for each of the physical display devices even though a single logical surface representing a desktop is spanned across multiple physical display devices 450, thereby confusing users as to which physical display devices 450 are actually being utilized by a given display topology.

In one embodiment, a user may indicate that they want to initiate desktop spanning across multiple physical display devices 450. The display driver 430 may be associated with a GUI that enables a user to select desktop spanning across multiple display devices 450. In another embodiment, the operating system 415 or another application may be configured to enable desktop spanning when one or more conditions have been met. For example, when the operating system 415 detects that two or more display devices 450 having the same characteristics have been connected to the system 400, desktop spanning may be enabled. In response to enabling desktop spanning, the display driver 430 simulates a hot-unplug event for each of the physical display devices 450 selected to participate in the spanned desktop environment. The operating system 415 receives a system message (e.g., a software interrupt) that notifies the operating system 415 that each of the physical display devices 450 has been removed from the system 400. The hot-unplug event is “simulated” because the physical display device 450 remains connected to the video interface 406. It will be appreciated that even though the operating system 415 removes the representation of the display devices 450 from the display topology maintained for the system 400, the physical display devices 450 are still physically connected to the system 400.

Once the display driver 430 has simulated the hot-unplug events for each of the physical display devices 450 participating in desktop spanning, the display driver 430 may simulate a hot-plug event for a logical display device that represents the plurality of physical display devices 450 participating in desktop spanning. The operating system 415 represents the logical display device as a single physical display device in the desktop topology even though the logical display device represents multiple physical display devices 450. Consequently, the GUI associated with the display driver 430 will correctly show a single display device in place of the multiple physical display devices 450 participating in desktop spanning.

Another issue with conventional methods for implementing desktop spanning environments is that some operating systems save settings associated with a particular hardware configuration in a database called a registry. The registry stores default display settings for when multiple display devices are connected to a system. In some cases, the default values stored in the registry may indicate that when multiple physical display devices 450 are connected to a system 400, the display topology should assign different surfaces to each of the physical display devices 450. Thus, whenever the system is restarted or whenever a hot-plug/hot-unplug event is detected, desktop spanning may be automatically disabled. When a user changes the settings in the display driver 430 to enable desktop spanning with a logical display device, the logical display device may be associated with a separate registry setting that indicates that desktop spanning should be automatically enabled.

In one embodiment, the display driver 430 may transmit Extended Display Identification Data (EDID) for the logical display device to the operating system. The EDID exposes the spanning capabilities for the logical display device. For example, the EDID includes manufacturer name, serial number, display timings, display size, and pixel mapping data for the logical display device. For example, when three 1920×1080 resolution display devices are utilized to implement desktop spanning, the EDID may indicate that the logical display device has a resolution of 5760×1080 pixels. The format for EDID is standardized by the Video Electronics Standards Association.

In one embodiment, the display driver 430 may calculate special values for various fields of the EDID. For example, a horizontal image size field and a vertical image size field in the EDID may be calculated by multiplying the values for the horizontal image size and the vertical image size included in the EDID of a physical display device 450 by the size of the display grid (i.e., an m×n display grid). In other words, the horizontal image size field in the EDID for the logical display device is set equal to the horizontal image size field in an EDID for one of the physical display devices 450 multiplied by the variable n in the display grid, and the vertical image size field in the EDID for the logical display device is set equal to the vertical image size field in an EDID for one of the physical display devices 450 multiplied by the variable m in the display grid. In this embodiment, it may be assumed that desktop spanning is implemented on only similar physical display devices 450 (i.e., all of the physical display devices 450 have the same visible surface dimensions). In another embodiment, different display devices may be utilized in the desktop spanning environment and the various values in the EDID may be calculated by summing the dimensions in the EDIDs for each of the display devices participating in the spanned desktop environment.

In another embodiment, the EDID includes an array of timings associated with each of the physical display devices 450. The display driver 430 may compare the timings included in the EDID for each of the physical display devices 450 and only include timings in the array of timings if the timings are similar. Other fields of the EDID may be calculated by the display driver 430 to represent the characteristics of the spanned desktop environment such as by encoding the dimensions of the display grid in a serial number field. It will be appreciated that other types of information may be encoded in various fields of the EDID.

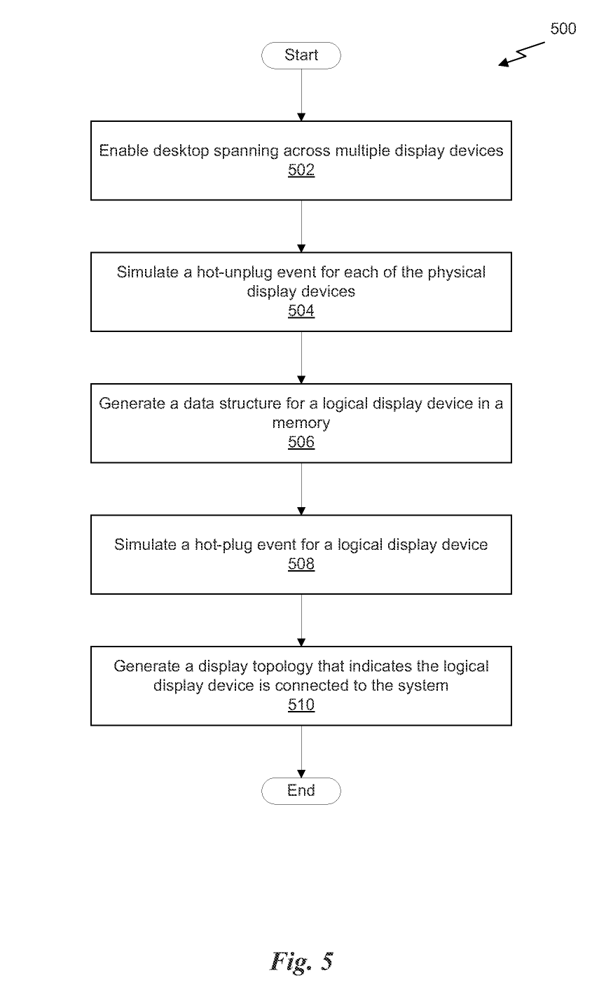

FIG. 5 illustrates a flowchart 500 of a method for representing a group of monitors participating in a desktop spanning environment to an operating system, in accordance with another embodiment. At step 502, desktop spanning across multiple physical display devices 450 is enabled. In one embodiment, a user enables desktop spanning by selecting an option in a GUI associated with the display driver 430. In another embodiment, desktop spanning is enabled when the display driver 430 detects that one or more conditions have been met. At step 504, the display driver 430 simulates a hot-unplug event for each of the physical display devices 450. In one embodiment, the display driver 430 generates a system message by initiating a software interrupt that indicates that the physical display devices 450 have been disconnected from the system 400. At step 506, the display driver 430 generates a data structure for a logical display device in a memory. In one embodiment, the data structure includes EDID for the logical device that represents information associated with the plurality of physical display devices 450 participating in desktop spanning.

At step 508, the display driver 430 simulates a hot-plug event for the logical display device. In one embodiment, the display driver 430 generates a system message by initiating a software interrupt that indicates that the logical display devices has been connected to the system 400. In another embodiment, the display driver 430 (and the display device 450) may generate a hardware interrupt via an interrupt request channel transmitted via a system bus. The operating system, in servicing the hardware interrupt, generates a call into the display driver 430 (via the API) to handle the interrupt. The display driver 430 may perform operations that cause the display topology to be reconfigured. At step 510, the operating system 415 creates a new display topology that indicates that the logical display device is connected to the system 400. The operating system 415 is unaware that the physical display devices 450 participating in desktop spanning are connected to the system.

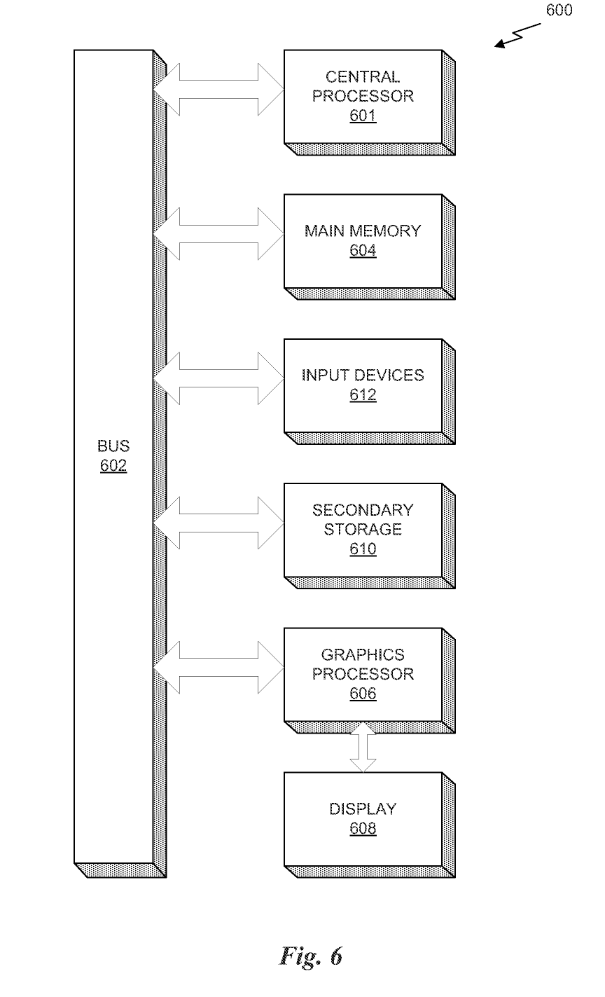

FIG. 6 illustrates an exemplary system 600 in which the various architecture and/or functionality of the various previous embodiments may be implemented. As shown, a system 600 is provided including at least one central processor 601 that is connected to a communication bus 602. The communication bus 602 may be implemented using any suitable protocol, such as PCI (Peripheral Component Interconnect), PCI-Express, AGP (Accelerated Graphics Port), HyperTransport, or any other bus or point-to-point communication protocol(s). The system 600 also includes a main memory 604. Control logic (software) and data are stored in the main memory 604 which may take the form of random access memory (RAM).

The system 600 also includes input devices 612, a graphics processor 606, and a display 608, i.e. a conventional CRT (cathode ray tube), LCD (liquid crystal display), LED (light emitting diode), plasma display or the like. In one embodiment, the display 608 comprises a plurality of physical display devices that are configured to implement a desktop spanning environment. User input may be received from the input devices 612, e.g., keyboard, mouse, touchpad, microphone, and the like. In one embodiment, the graphics processor 606 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 600 may also include a secondary storage 610. The secondary storage 610 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 604 and/or the secondary storage 610. Such computer programs, when executed, enable the system 600 to perform various functions. The memory 604, the storage 610, and/or any other storage are possible examples of computer-readable media.

In one embodiment, the architecture and/or functionality of the various previous figures may be implemented in the context of the central processor 601, the graphics processor 606, an integrated circuit (not shown) that is capable of at least a portion of the capabilities of both the central processor 601 and the graphics processor 606, a chipset (i.e., a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 600 may take the form of a desktop computer, laptop computer, server, workstation, game consoles, embedded system, and/or any other type of logic. Still yet, the system 600 may take the form of various other devices including, but not limited to a personal digital assistant (PDA) device, a mobile phone device, a television, etc.

Further, while not shown, the system 600 may be coupled to a network (e.g., a telecommunications network, local area network (LAN), wireless network, wide area network (WAN) such as the Internet, peer-to-peer network, cable network, or the like) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method, comprising:
simulating a hot-unplug event for a plurality of display devices configured to participate in a spanned desktop environment; and
simulating a hot-plug event for a logical display device that represents the plurality of display devices.

2. The method of claim 1, wherein simulating a hot-unplug event comprises generating an interrupt that indicates to an operating system that the physical display device has been disconnected.

3. The method of claim 1, wherein simulating a hot-plug event comprises generating an interrupt that indicates to an operating system that the logical display device has been connected.

4. The method of claim 1, further comprising enabling desktop spanning based on input received from a user via a graphical user interface associated with a display driver.

5. The method of claim 1, further comprising enabling desktop spanning based on one or more conditions detected by a display driver.

6. The method of claim 1, further comprising generating a data structure for the logical display device in a memory.

7. The method of claim 6, wherein the data structure includes Extended Display Identification Data (EDID) that exposes capabilities of the logical display device.

8. The method of claim 7, wherein the EDID includes data that indicates a combined resolution for the plurality of display devices.

9. The method of claim 8, wherein the data that indicates a combined resolution for the plurality of display devices is generated by summing visible surface dimensions for each of the plurality of display devices.

10. The method of claim 7, wherein the EDID includes data that indicates an arrangement of the plurality of display devices.

11. The method of claim 1, wherein an operating system, in response to receiving a notification of the hot-plug event, generates a display topology that includes a representation of the logical display device.

12. The method of claim 1, wherein the spanned desktop environment comprises at least one surface stored in a memory that includes pixel data for display on the plurality of display devices.

13. A non-transitory computer-readable storage medium storing instructions that, when executed by a processor, cause the processor to perform steps comprising:
simulating a hot-unplug event for a plurality of display devices configured to participate in a spanned desktop environment; and
simulating a hot-plug event for a logical display device that represents the plurality of display devices.

14. The computer-readable storage medium of claim 13, further comprising generating a data structure for the logical display device in a memory, wherein the data structure includes Extended Display Identification Data (EDID) that exposes capabilities of the logical display device.

15. A system, comprising;
a plurality of display devices configured to participate in a spanned desktop environment; and
a processing unit configured to:
simulate a hot-unplug event for the plurality of display devices; and
simulate a hot-plug event for a logical display device that represents the plurality of display devices.

16. The system of claim 15, further comprising:
one or more parallel processing units coupled to the plurality of display devices; and
a display driver executed by the processing unit and associated with the one or more parallel processing units.

17. The system of claim 16, wherein the display driver is configured to simulate a hot-unplug event for the plurality of display devices by generating an interrupt that indicates to an operating system that the physical display device has been disconnected.

18. The system of claim 16, wherein the display driver is configured to simulate a hot-plug event for the plurality of display devices by generating an interrupt that indicates to an operating system that the logical display device has been connected.

19. The system of claim 16, wherein the processing unit and the one or more parallel processing units are implemented in a System-on-Chip (SoC).

20. The system of claim 16, wherein the display driver is configured to generate a data structure for the logical display device in a memory, wherein the data structure includes Extended Display Identification Data (EDID) that exposes capabilities of the logical display device.
